(19) United States
(12) Patent Application Publication
(10) Pub. No.: US 2011/0289318 A1
(43) Pub. Date: Nov. 24, 2011

(54) System and Method for Online Digital Signature and Verification

(76) Inventors: Jingsong Zhang, Wylie, TX (US); Yumei Jin, Wylie, TX (US)

(21) Appl. No.: 12/200,891

(22) Filed: Aug. 28, 2008

(51) Int. Cl. H04L 9/32

(52) U.S. Cl. 713/176

(57) ABSTRACT

A method to sign online documents may include the steps of loading a signing component from a remote server, automatically launching signing component at user local machine(PC, PDA or smart phone . . .), displaying signing component user interface in web page , entering a password and loading/applying a first key file in cooperation with the signing component, verifying the password and verifying first key, applying the first key to a document digest to generate a digital signature based on the document digest and first key.

### FIELD OF THE INVENTION

The present invention relates to the ability to digitally sign documents online and more particularly to a method and system to digitally sign an electronic document and to digitally verify the signature.

### BACKGROUND

Allowing users to sign documents online and the ability to verify signatures online are an important part of business transactions today.

The dominant technology under prior art for individuals to sign electronic documents and transaction data is based upon client-side digital signatures. The signatures are created by software that uses an encryption algorithm, called a private key, of the user to electronically encode the electronic document or transaction data. A mathematically related algorithm, called the public key corresponds to the private signature key. The public key is used by the recipient to verify the authenticity of the electronic document or data and the integrity of the data since signing occurred, including the fact that it has not been changed or altered since the signature was affixed. Digital certificates issued by trusted third parties called certification authorities identify public keys of the presumptive true owners of the private keys that were used for signing, thus assuring that the signer is in fact the person who purported to sign the document or data.

An example of a system of digital signatures is shown in U.S. Pat. No. 4,405,829 to Rivest et al. (1983). It is based upon a technology commonly referred to as “asymmetric encryption.” In this technology, a user generates two mathematically related numbers based upon prime numbers, called keys. The so-called private key remains with the issuing user. It is kept secret. The other key, denominated the public key, can be freely distributed by the issuer to others. The keys are related, but they are not identical. They perform reverse roles. One is used to encrypt information, and the other to decrypt it. With respect to signatures, one key affixes the signature and other is used to verify it and the electronic document contents.

Electronic communications are signed, generally with the private key, in a two step process. First a digest of a message is created with a one way hash function, and then the digest of a message is encrypted using the private key.

The authenticity of the message and its contents can be verified by a recipient as being authentic and sent from the signing party by testing the message using the public key. An altered message or fraudulent sender will be detected by a computer possessing the proper software and the public key. If either the message has been altered since signing or alternatively the signer did not use the proper private key, the signature will be reported as false or inauthentic. This method is useful for electronic authentication.

However, to the extent that this method of authentication occurs using individual desktop or laptop computers that are identified to others through a system of digital certificates, it also requires a massive infrastructure for key management and verification by trusted third parties, called certification authorities. These certification authorities verify the identities of individual key holders before issuing certificates to them. Once identity is confirmed, they sign the public key of the individual with the certification authority's private key. They also allow others to verify that the public key of the key pair belongs to the party who is identified as the holder of the key pair, and maintain lists of active and revoked certificates for use by third parties that rely upon the certificates to prove identity. Authentication by a relying party requires not only a check of the digital signature on the message, but also of the status of the certificate identifying the signer, to make sure that it is still valid. This involves accessing the certificate authority computer and checking its lists of revoked and suspended certificates. The investment to create and operate a commercial or large enterprise-wide certification authority is considerable. Legal requirements of periodic audits impose other costs.

The digital certificates from certification authorities identify the owner of the key pair principally through the owner's public key that was signed by the certification authority at the time of issue. No other identification is made part of the certificate—no picture identification, fingerprint identification, handwriting exemplar, voice print, finger print, retinal scan, or other additional proof in the certificate of the owner's personal identity. Without such other proof as part of the certificate itself, there is no personal identification of the owner to protect the certificate from subsequent wrongful use. An identity check is performed by the certification authority at the time that the public key is signed, but not afterwards. This makes it possible for an unauthorized person who comes into possession of the private key and the certificate of another to claim the identity of the true owner for purposes of one or more transactions over the Internet. The assumed identity can continue until the wrongful use is discovered and the certificate is revoked by the certification authority. Under the laws of many states, the true owner could be bound to a transaction involving wrongful certificate use up to the moment of certificate revocation because there is no other proof of identity needed or required to complete a transaction other than possession of the private key that corresponds to the public key which was signed by the certification authority. This risk is usually placed upon the key owner by contractual agreement, governing law, or custom, and may be protected against by insurance or warranty coverage.

Obtaining possession of the private key without authorization of the owner is not impossible using currently available technology. Private keys left on the hard drive of the owner's computer are subject to various computer attacks. Because the true owner gains access to the private key on the computer's hard drive generally using an unencrypted password, anyone who can learn or decipher this password has equal access. A password can be deciphered through a brute force dictionary attack. All possible permutations and combinations are generated electronically on another computer until the proper password is reconstructed. Generally, there is no check on the number of failed attempts to access the password, the public key or logging device built into the software.

### SUMMARY

A method to sign online documents may include the steps of loading a signing component from a remote server, automatically launching signing component at local machine (PC, PDA or smart phone . . .), displaying signing component user interface in web page, entering a password and loading/applying a first key file in cooperation with the signing component, verifying the password and verifying first key, applying the first key to a document digest to generate a digital signature based on the document digest and first key.

A method to Generate a pair of first key and second key may include the steps of loading key generation component from remote server, automatically launching key generation component from local machine (PC, PDA or smart phone . . .), displaying the key generation component user interface on web page, verifying user password and security question answers against user profile in remote server, key generation component generating first key and second key at local machine (PC, PDA or smart phone . . .), key generation component storing the encrypted first key to a user selected file at local machine. key generation component uploading second key to remote server.

A method to verify a digital signature may include the steps of obtaining a second key which corresponds to the private key, verifying the digital signature based on the second key.

The first key may be a private key, and the second key may be a public key.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a system diagram of the present invention;

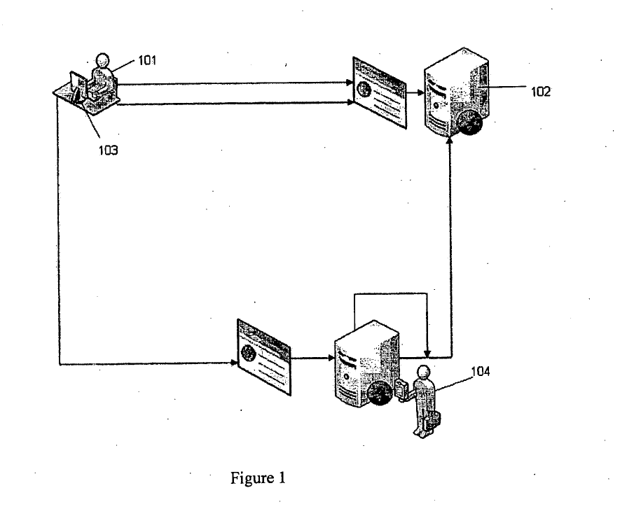

FIG. 2 illustrates a screenshot that can be used by the sending user to enter profile to the proprietary website of a remote server;

FIG. 3 illustrates a screenshot that can be used by the sending user to create a new user account onto the proprietary website of a remote server;

FIG. 4 illustrates a screenshot of the key generation component launched and displayed in proprietary web page which will verify user password and security question answer in order to generate a public-private key pair;

FIG. 5 illustrates a screenshot of the key generation component saving the locally generated private key to a local key file and the public key to the remote server;

FIG. 6 illustrates a screenshot of the key generation component which has been completed successfully, indicating that the public key and the private key has been generated and saved;

FIG. 7 illustrates an example of a private key that has been generated;

FIG. 8 illustrates a screenshot where the sending user is making a payment to the receiving user and illustrates the signing component for the sending user to apply the private key file and password to sign the payment;

FIG. 9 illustrates that the signed data has been generated and displayed in a sample format;

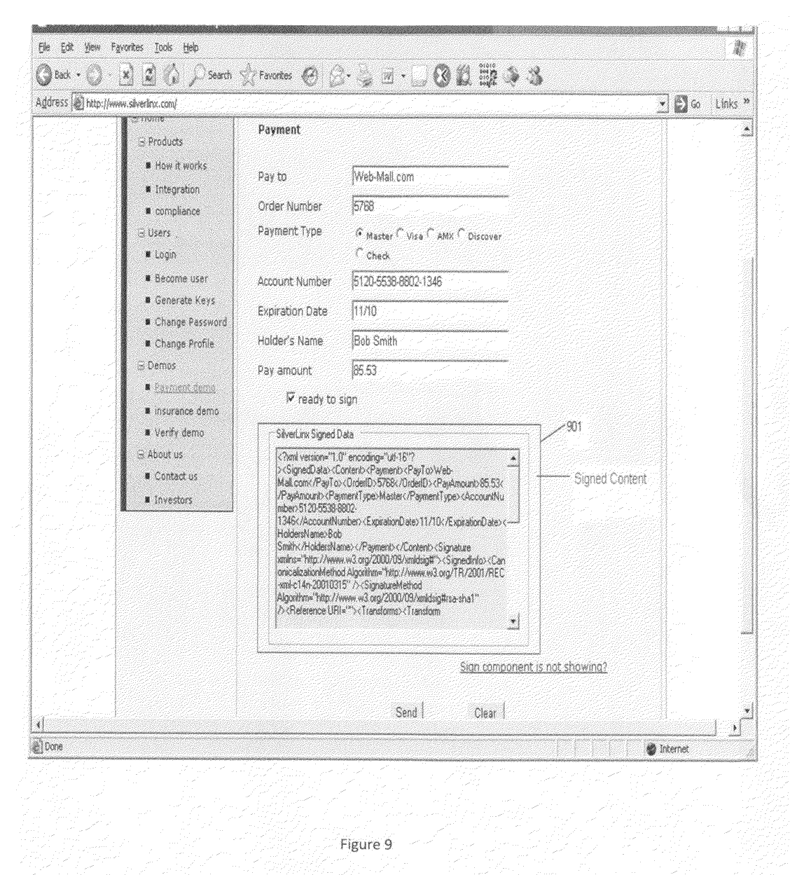

FIG. 10 illustrates an example of the signed document;

FIG. 11 illustrates an example of a screenshot to attain verification of the signed document;

FIG. 12 illustrates the results of the verification that has failed due to a modification of the signed document;

FIG. 13a illustrates the operation for user sign up and system setting diagram,

FIG. 13b illustrates the operation of the key generation diagram,

FIG. 13c illustrates the operation of the user sign Web content diagram, and

FIG. 13d illustrates the operation of the receiving user verifying the digital signature diagram.

### DETAILED DESCRIPTION

The present invention provides a system and method to enable an e signature (electronic signature) solution which allows the user to digitally sign content from a webpage which may be online. The present invention does not require additional hardware and does not require the user to manually install additional software. Instead, the present invention utilizes software component embedded in webpage to sign web content without the need to leave the webpage. The present invention includes embedded software components which include a user key generation component and a user signing component. The key generation component generates a user public key and a private key at the user's local machine. The public key may be sent to a remote server 102 through a network for signature verification. The private key may be saved at the user's local device in order to avoid a security problem. The signing component may use cypto algorithms such as a symmetric, an asymmetric, hash and digital signing methods to sign data. The signed result may be compliant with ‘World Wide Web Consortium (W3C) specification for XML signing and verification’. Consequently, the signed result can be verified substantially immediately.

The user identity may be verified when the user signs up for membership or when the user signs up to create new account.

With the present invention, the user can sign Web content online without leaving the webpage of the retailer or other web pages where a signature may be required. Retailers or receiving users can integrate the software of the present invention with their existing system, and no additional database nor additional server is required. The teachings of the present invention are applicable to multiple signatures.

The present invention embeds the key generation component and the signing component into Web content in order to provide a fully integrated, run locally and automatically installed facility in the user's personal computer (PC) or device.

The user should be picture ID verified when the user activates the user account. The user generates their own keys (both a public key and a private key) which avoid the need for a centralized key generation and distribution method. The user's private key may be applied on the user local machine avoiding the need for the private key to be sent across the network or Internet. The user has full control of their keys which can be regenerated whenever the user desires.

The advantages of the present invention may include that it is highly portable so that the user can sign online content anywhere by using a key file. The user has full control of their keys, and the keys can be regenerated at any time. The present invention does not require a certificate. The software components are embedded in a webpage. Consequently there is no need to manually install these components. The present invention does not require additional hardware. The key generation component and the signing component may run on the user's local machine therefore the private key is not sent across the network or Internet. The user can instantly sign a document on the webpage without the need to leave the webpage. The signed document can be verified instantaneously and programmatically. The signed document is only exchanged between the sender and receiver. A third-party is not involved.

The teachings of the present invention can be modified to comply with regulations, both global and national.

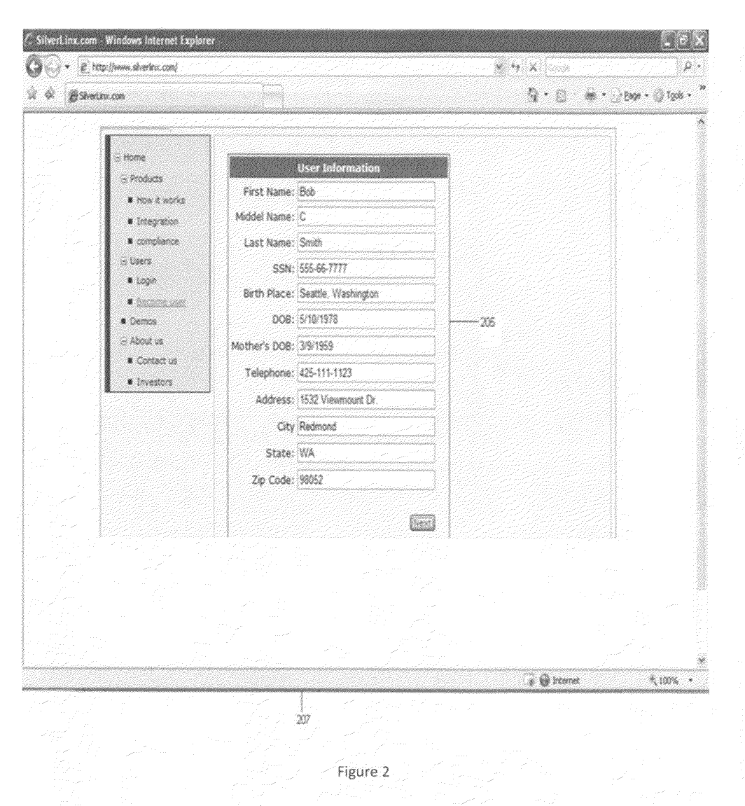

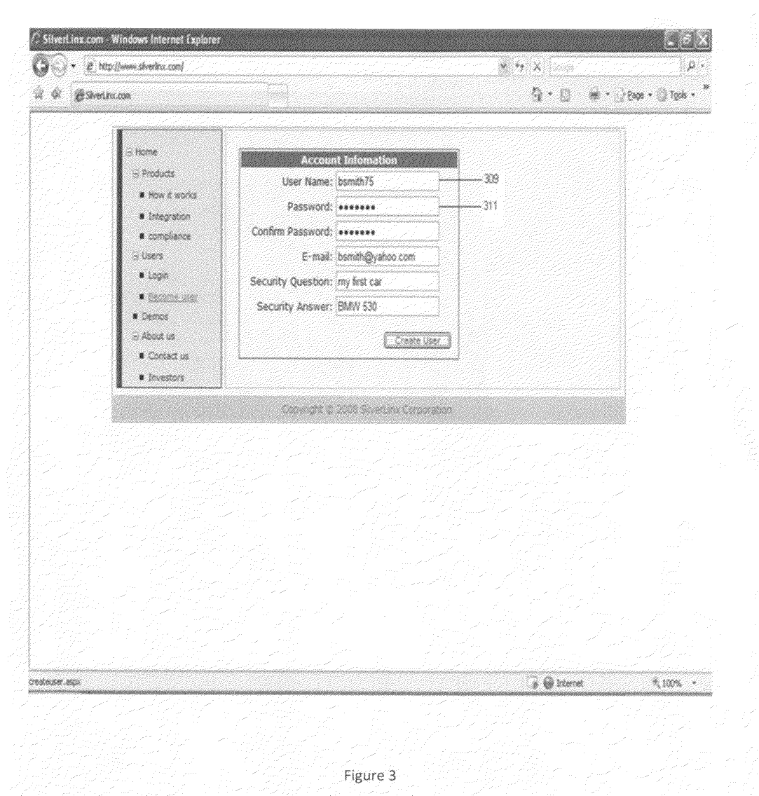

The sending user 101 signs up to the proprietary webpage of the remote server 102 for example by using a personal computer 103 or laptop or other type of device and by entering a profile 205 (FIG. 2) into the proprietary webpage of the remote server 102 which describes information about the sending user. As part of the sign up, the sending user 101 chooses a login name 309 (FIG. 3) and password 311 to activate the account on the proprietary webpage of the remote server 102, and the sending user 101 may submit a picture ID to be verified or verified by a selected party/method.

The sending user 101 generates both a public key and private key from the proprietary webpage of the remote server 207 (FIG. 2) for use of the sending user. When the sending user 101 opens the proprietary webpage of the remote server 102, a key generation component will be downloaded to run on the personal computer 103 of the sending user 101. The key generation component may assist the sending user 101 in generating a private key and a public key. The private key may be saved by the sending user 101 locally on the personal computer or portable device such as a USB drive. By private key, what is intended is that the private key not be shared by other users. The key file associated with the private key may be encrypted and may be secured by a password of the sending user. The public key is transferred to a database and associated with the proprietary webpage of the remote server 102 so that it can be accessed when required. The sending user 101 can generate many public and private key pairs, but only one pair of public key and private key may be active at any given time. If the private key is lost, the user may generate a new public-private key pair.

The sending user 101 now has the ability to sign a web content of a receiving user 104.

The sending user 101 may go to the website of a receiving user 104 and the website may include an embedded signing component and web content which the receiving user 104 desires the sending user 101 to sign. The sending user 101 provides the private key which may be in the form of a file and password to the embedded signing component. Signing component verifies private key and password against user information in remote server 102, and the embedded signing component will generate a digital signature for the Web content by using the private key. The signed document may be transmitted to the receiving user 104. The signed document may be in compliance with XMLDSIG standards (the World Wide Web Consortium (W3C)) specification for XML signing and verification. Consequently, the signed document may now be verified by the XMLDSIG standard verification method.

### Sign Up

The sign-up procedure includes entering the profile, creating accounts and verifying the user's identity by use of a picture ID. The verification of the user's identity may be with the aid of a third-party to physically provide the verification of the user with the picture ID. This assures that a good-faith sending user 101 may sign up to the proprietary website of a remote server 102. FIG. 2 illustrates a screenshot that can be used by the sending user 101 to sign up to the proprietary website of a remote server 102. FIG. 3 illustrates a screenshot that can be used by the sending user 101 to generate or create a new user account onto the proprietary website of a remote server 102.

### Generate Keys

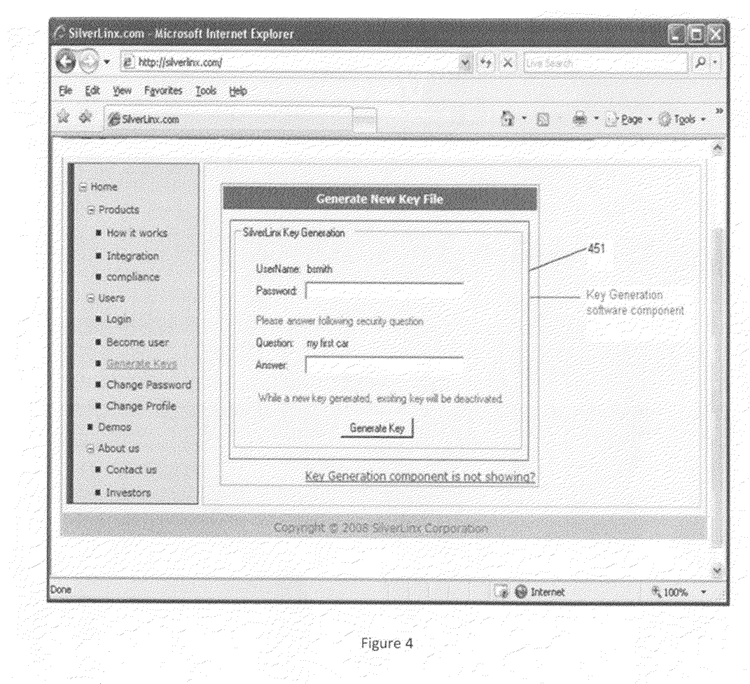

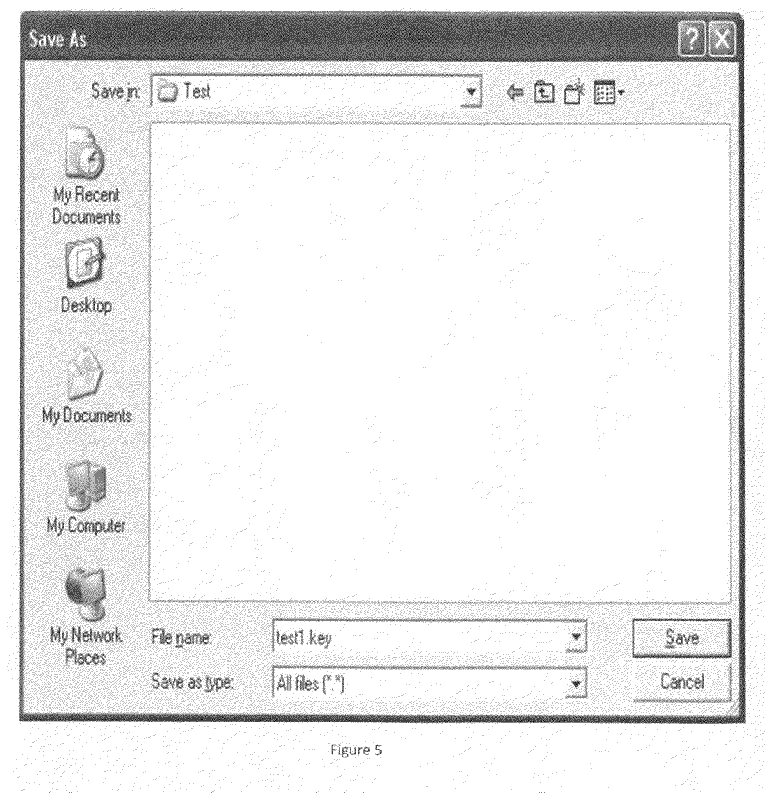

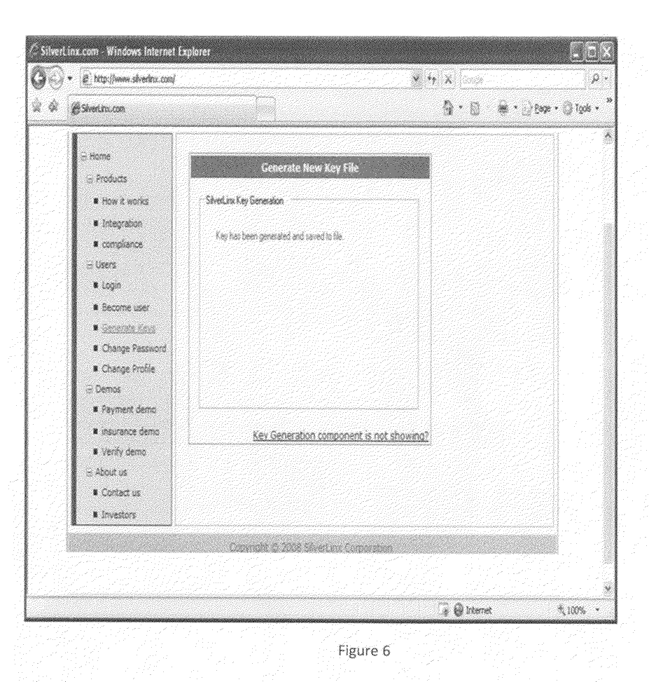

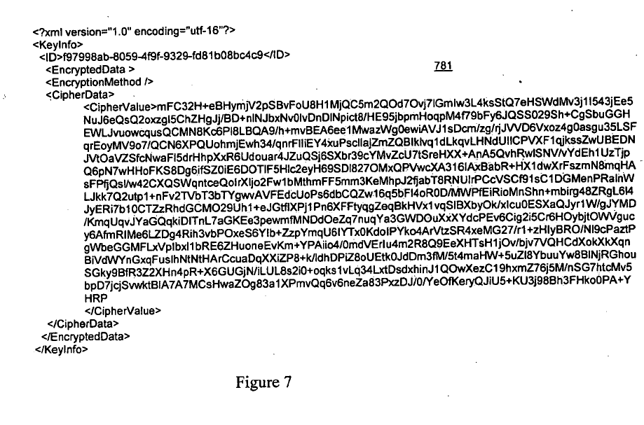

When the sending user 101 becomes a member of the proprietary website of a remote server 102, the sending user 101 is able to generate his or her signing keys which may include a private key and a public key. The proprietary website of a remote server 102 will automatically load a key generation component 451 (FIG. 4) on the sending user's PC 103 and will begin to run to generate the public and private key. The key generation component 451 may upload the public key to the proprietary website of a remote server 102 and save the private key of the sending user 101 in appropriate file. FIG. 4 illustrates a screenshot of the key generation component 451 launched and displayed in proprietary website of a remote server 102 which will verify user password and security question answer in order to generate a public-private key pair. FIG. 5 illustrates a screenshot of the key generation component 451 saving the private key to the local device of the sending user. FIG. 6 illustrates a screenshot of the key generation component indicating that the public key and the private key has been generated and saved. FIG. 7 illustrates an example of a private key file 781 that has been generated. The key in the file has been encrypted.

The private key which may be a private key file should be kept in a safe and secret area, and the private key may be used only with the password of the sending user 101. The sending user 101 can generate a new key file at any time and old keys will be deactivated by the proprietary website of a remote server 102. Old keys can be used for verification, but the old keys cannot be used for generating signatures.

### Digital Signature Generation

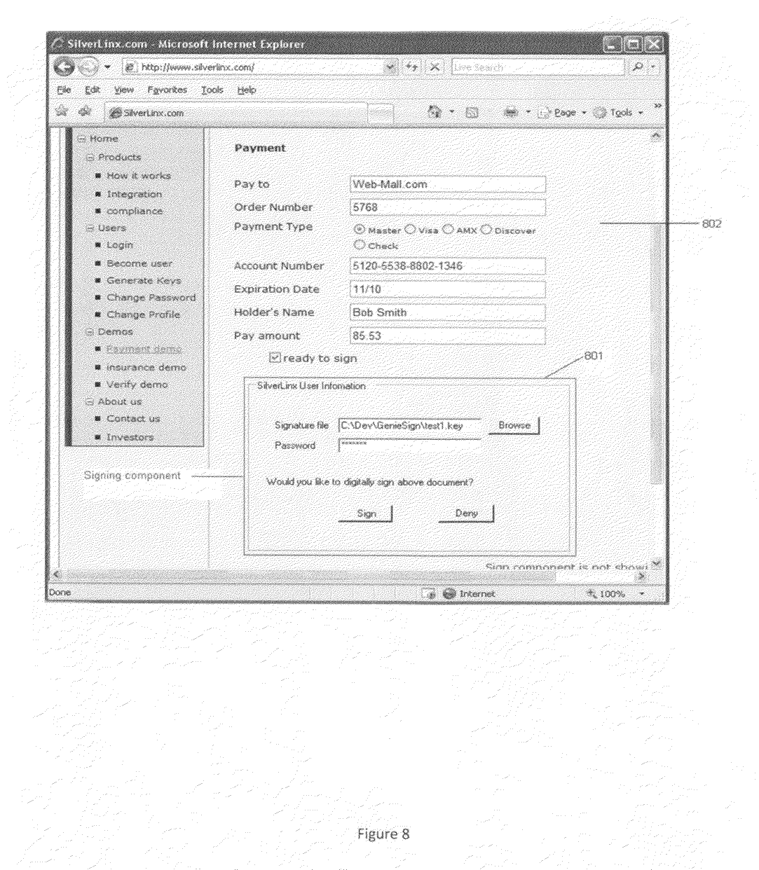

FIG. 8 illustrates a screenshot where the sending user 101 is making a payment 802 to the receiving user 104. The receiving user 104 may add the digital signature signing component on the website of the receiving user 104. When the sending user 101 goes to the featured page of the receiving user 104, the signing component 801 loads onto the personal computer 103 including laptops and other such devices and launches to enable the digital signature feature.

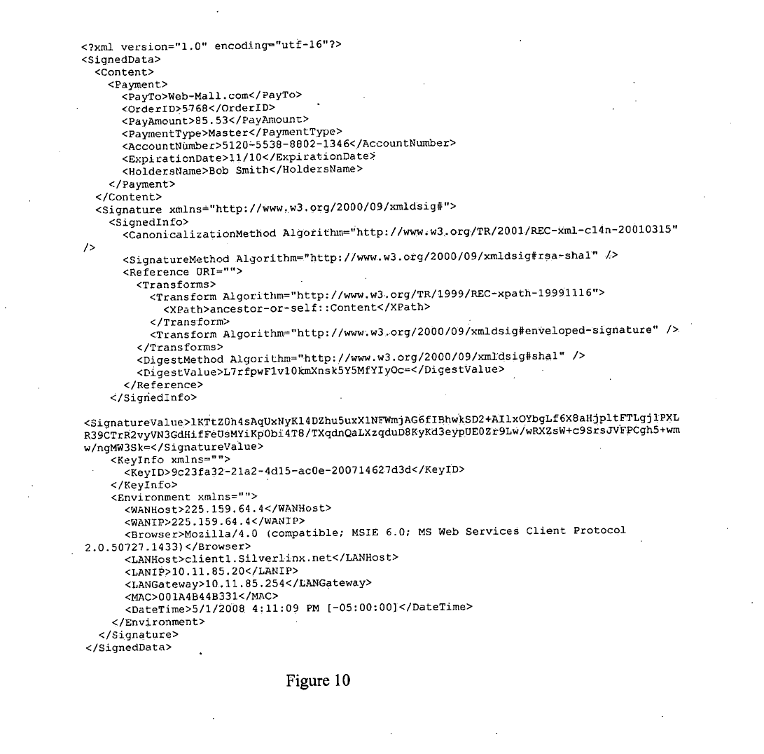

After the sending user 101 completes the contract form with the receiving user 104 and agrees to sign it by using the web content document 802, control passes to the signing component 801 for the sending user 101 to apply the private key file and password to the signing component 801 as illustrated in FIG. 8. The signing component 801 may generate the signed document 901 and may send the signed document to the Web server of the receiving user 104. FIG. 10 illustrates the signed document by example that includes the data that the user is required to sign, the signature information, the digital signature, system environment information and user information.

The signed document may be in standard XMLDIG (the World Wide Web Consortium (W3C) specification for XML signing and verification) or other appropriate XML formats. Since the signed document is in this XML format, it can be verified by verify software in compliance with XMLDIG. The environment section in the signature document include the system information and timestamp of the sending user 101 to identify the system location in the Internet which may be important for auditing and investigative purposes.

### Receiving User Integration

In order to add the digital signature feature to their website, receiving user may integrate signing component in their existing web page. An object tag element and JavaScript functions may be used to send the content to the signing component and to receive the signed result from the signing component.

### Receiving User Verifies the Digital Signature.

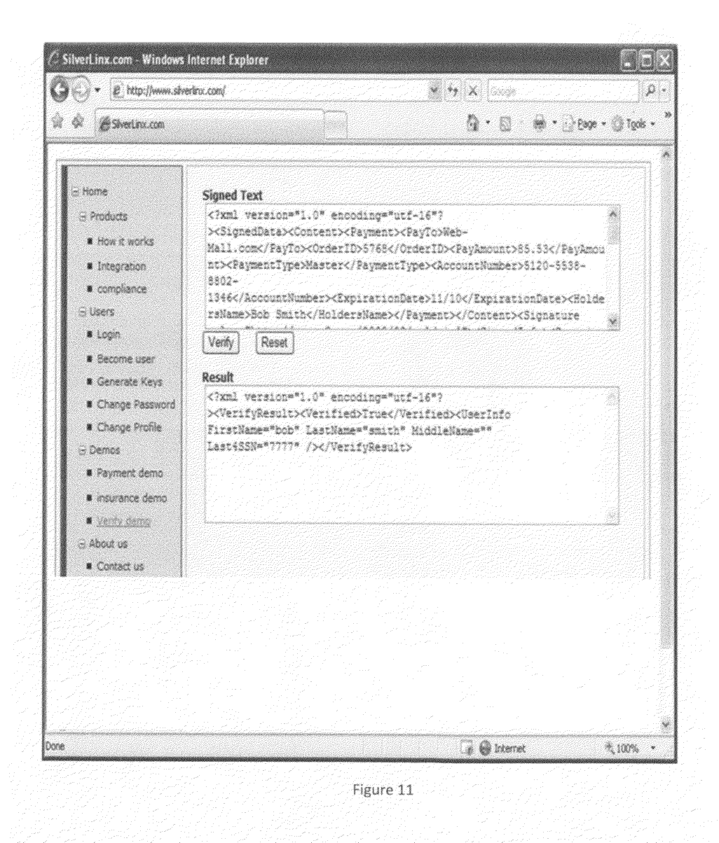

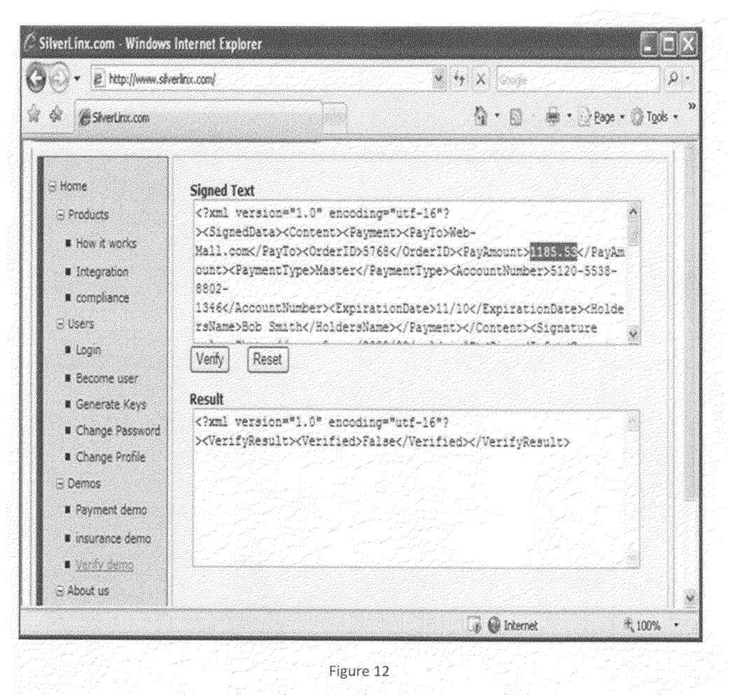

After the receiving user 104 receives the signed document, the signed document can be verified to determine that the sending user 101 had signed the signed document. FIG. 11 illustrates the screenshot to attain verification of the signed document. Changes to the signed document can be detected to indicate that the document had been tampered with. FIG. 12 illustrates the results of the verification of the signed document.

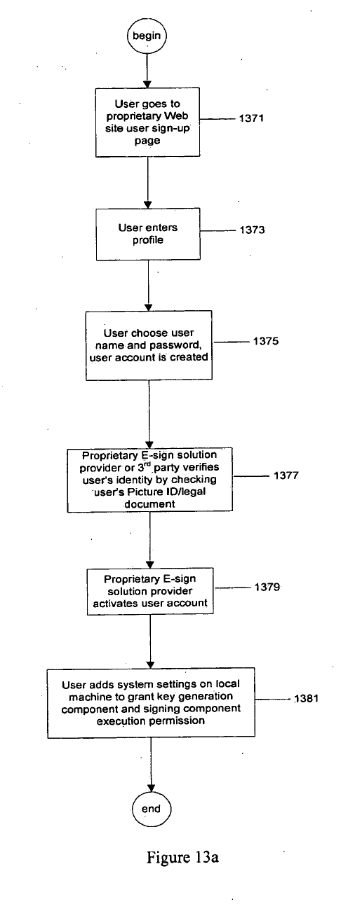

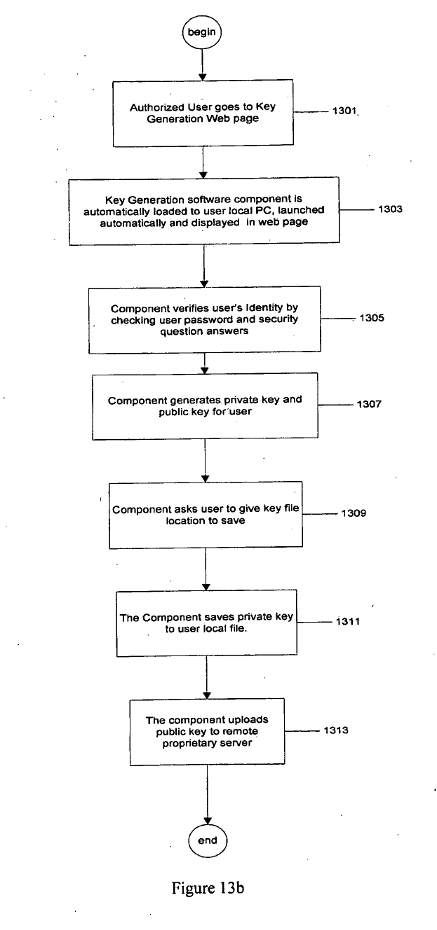

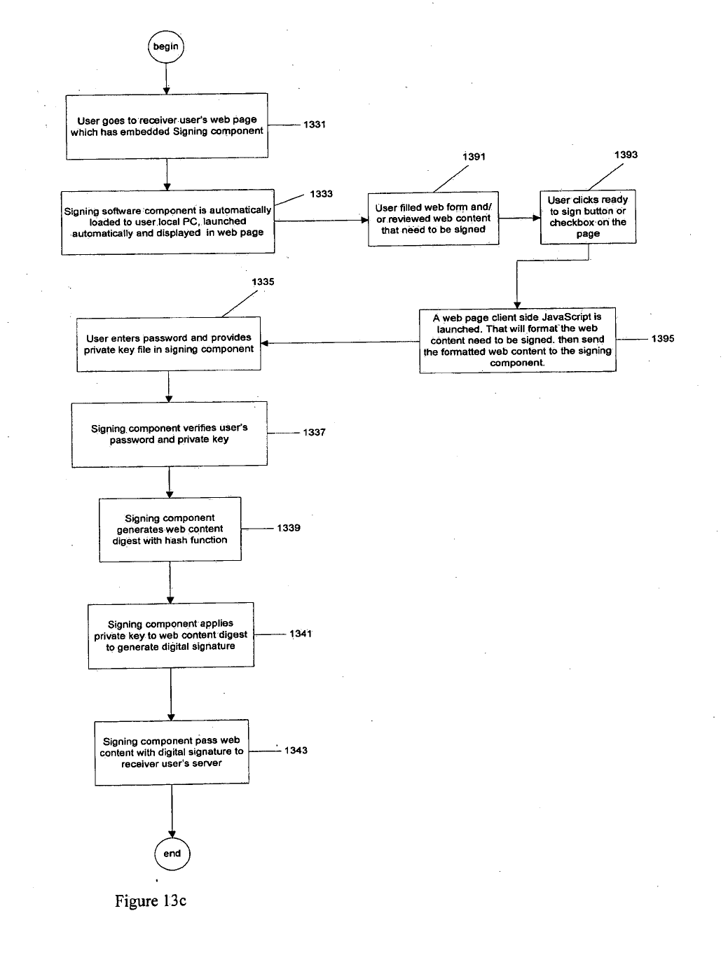

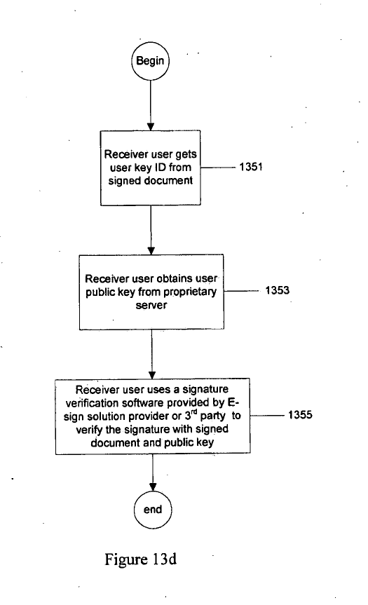

FIGS. 13a, 13b, 13c and 13d illustrate the operation of the present invention.

In FIG. 13a, the user sign up and system setting is illustrated. In step 1371, the user goes to the proprietary website user sign-up page to sign up. In step 1373, the user enters the profile of the user and may provide such information such as address, e-mail address, Social Security number or other such information. In step 1375 the user selects a username and a password for access to the account, and a user account is created. Next in step 1377, a proprietary E-sign solution provider or third-party verified the users identity for example by checking a picture ID of the user or examining a legal document such as a driver's license or Social Security card presented to the third-party by the user. In step 1379, the proprietary E-sign solution provider activates the user account if the users identity is verified. In step 1381, the user adds system settings on the local machine to grant the key generation component and the signing component execution permission.

FIG. 13 b illustrates how the keys are generated. More particularly, in step 1301, the authorized user goes to the key generation webpage, and the key generation software component automatically is loaded to user local PC, launched automatically and displayed in the webpage in step 1303. In step 1305, the component verifies the users identify by checking the user password and security question answers, and the component generates the private key and the public key for the user in step 1307.

In step 1309, the component asks the user to give the key file location in order to save the private key, and the component saves the private key to the user local file in step 1311. The component uploads the public key to the remote proprietary server in step 1313.

FIG. 13b illustrates the steps for the signing Web content. In step 1331, the user goes to the receiver user's webpage which may include the embedded signing component, and the signing software component automatically is loaded to the local PC of the user, is launched automatically and is displayed on the webpage in step 1333. In step 1391, the user filled Web form and/or reviewed Web content that is required to be signed. In step 1393, the user clicks ‘ready to sign’ button or alternatively activates a checkbox on the page. In step 1395, a web page client-side JavaScript is launched. This will generate the format for the Web content to be signed and the formatted Web content is transferred to the signing component. In step 1335, the user enters the password and provides the private key file, and the component verifies the user password and private key by obtaining information retrieved from the proprietary remote server in step 1337. In step 1339, a document digest is generated with a hash algorithm, and the component applies the private key to the document digest to generate the digital signature in step 1341. The component pass the document with the digital signature to the server of the receiver user in step 1343.

FIG. 13d illustrates the steps to verify the digital signature.

In step 1351, the receiver user retrieves the user key ID from the signed document, and the receiver user obtains the user public key from the proprietary server in step 1353. In step 1355, the receiver user uses signature verification software provided by the proprietary E-sign solution provider or third-party in order to verify the signature with the signed document and public key.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A method to generate and verify a digital signature, comprising the steps of:
loading and embedding a signing component from a remote server;
entering a password and applying a first key in cooperation with the embedded signing component;
verifying the password and first key against the remote server with the embedded signing component;
applying the first key to a document digest to generate a digital signature based on the document digest and first key;
obtaining a second key which corresponds to the first key; and
verifying the digital signature based on the second key.

2. A method to generate and verify a digital signature as in claim 1, wherein the method includes downloading the signing component to a local machine.

3. A method to generate and verify a digital signature as in claim 2, wherein the method includes viewing the signing component on the local machine.

4. A method to generate and verify a digital signature as in claim 1, wherein the method step of viewing the signing component on a webpage on a local machine.

5. A method to generate and verify a digital signature as in claim 1, wherein the method step of running the signing component on a local machine.

6. A method to generate and verify a digital signature as in claim 5, wherein the first key and the second key may be regenerated by the user in cooperation with a key generation component.

7. A method to generate and verify a digital signature as in claim 1, wherein the first key is a private key and only stored on the local machine.

8. A method to generate a digital signature, comprising the steps of:
entering a password and applying a first key in cooperation with an embedded signing component; and
applying the first key to a document digest to generate a digital signature based on the document digest and first key.

9. A method to generate a digital signature as in claim 8, wherein the method includes downloading the signing component to a local machine.

10. A method to generate a digital signature as in claim 9, wherein the method includes viewing the signing component on the local machine.

11. A method to generate a digital signature as in claim 8, wherein the method step of viewing the signing component on a webpage on a local machine.

12. A method to generate a digital signature as in claim 8, wherein the method step of running the signing component on a local machine.

13. A method to generate a digital signature as in claim 8, wherein the first key and the second key may be regenerated by the user in cooperation with a key generation component.

14. A method to generate a digital signature as in claim 8, wherein the first key is a private key and only stored on the local machine

15. A method to generate a signing component and to sign a digital signature, comprising the steps of:
loading and embedding a signing component from a remote server;
verifying a password and first key against the remote server with a embedded signing component; and
applying the first key to a document digest to generate a digital signature based on the document digest and first key.

16. A method to generate a signing component and sign a digital signature as in claim 15, wherein the method includes downloading the signing component to a local machine.

17. A method to generate a signing component and to sign a digital signature as in claim 15, wherein the method includes viewing the signing component on the local machine.

18. A method to generate a signing component and to sign a digital signature as in claim 15, wherein the method step of viewing the signing component on a webpage on a local machine.

19. A method to generate a signing component and to sign a digital signature as in claim 15, wherein the method step of running the signing component on a local machine.

20. A method to generate a signing component and to sign a digital signature as in claim 15, wherein the first key and the second key may be regenerated by the user in cooperation with a key generation component.
